(19) United States
(12) Patent Application Publication
(10) Pub. No.: US 2007/0102951 A1
(43) Pub. Date: May 10, 2007

(54) Adjustable spline coupling for truck bed cover mechanism

(76) Inventor: Lynn Chenowth, Rodeo, NM (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 11/271,569

(22) Filed: Nov. 10, 2005

(51) Int. Cl. B60J 11/00

(52) U.S. Cl. 296/98

(57) ABSTRACT

A cover deployable over the cargo compartment of a truck comprises a tarpaulin sheet wound about a motor-driven reel mounted close to the front or rear edge of the compartment. The outer free edge of the sheet is secured to a crossbar spanning the width of the compartment. The opposite ends of the crossbar are rotatively attached to the upper extremities of a pair of bows pivotingly traveling in planes parallel to the sides of the compartment. The bows' lower extremities are anchored into a pivot assembly resiliently biased to unroll the sheet from the reel and spread it over the compartment. A multi-position coupler between each bow and pivot assembly is used to adjust the tension applied to the sheet that must be overcome by the reel motor by varying in discrete minute amounts the angular position of the bow in relation to the pivot assembly. The pivot assembly is coupled to the bow by a spline shaft having a large number of peripheral indentations meshing with corresponding indentations distributed around the wall of a mating circular cavity of the coupler.

### FIELD OF THE INVENTION

This invention relates to covers for truck beds, and more particularly to pivot assemblies for the side bows used to deploy such covers.

### BACKGROUND

In many jurisdictions, the law requires that trucks and trailers used in the transport of various materials such as sand, gravel, grain, trash or other loose substances have a cargo area fully covered by a tarpaulin sheet or a net in order to prevent transported material to be blown away and cause a driving hazard for following vehicles or dump litter on the highway.

The tension applied to the truck bed cover by the pivot assembly of the deploying bows must be carefully adjusted within a relatively narrow range. The tension must be sufficient to cause a deployment of the cover sheet over the entire truck bed. Yet, it must not be so high as to overcome, or put undue strain upon the motor that drives that reel upon which the retracting cover is wound.

Typical prior adjustment systems are exemplified by those disclosed in U.S. Pat. Nos. 5,031,955 and 5,887,937 Searfoss. These two patents are incorporated in this specification by this reference. The prior art tension adjustment devices are either cumbersome, unstable or imprecise due to the large increments between the various adjustable positions. Further, fine adjustment mechanisms can create additional entry points for water and dirt to get into the internal mechanisms and cause fouling, rust and undue wear.

The instant invention results from an attempt to achieve a more compact, precise and more convenient way to adjust the tension of the pivoting bows.

### SUMMARY

The invention provides a convenient way to adjust the tension applied on a pivoting bow by coupling a resiliently biased rotating shaft to the lower end of a cover-deploying bow by means of a spline assembly that allows minute incremental, angular positioning of the bow in relation to the shaft.

In some embodiments there is provided an apparatus for pivotally mounting a bow along the side of a truck, which comprises a frame secured to the truck; a shaft rotationally journaled into said frame along an axis substantially perpendicular to said side; a biasing mechanism between said shaft and said frame, said mechanism urging said shaft to rotate in a first direction within a plane substantially parallel to said side; and a coupler having a first portion secured to a lower end of said bow and a second portion adjustably attachable to an outer end of said shaft in a plurality of discrete angular orientations within said plane.

In some embodiments said angular orientations are regularly separated by no more than about 12 degrees. In some embodiments said outer end comprises at least one radial protrusion projecting from the periphery of said shaft. In some embodiments said second portion has a cavity shaped and dimensioned to be engaged by said outer end, said cavity having a plurality of radial depressions distributed along the periphery of said cavity, each of said depressions being shaped, dimensioned and positioned to selectively mate with said protrusion. In some embodiments said outer end has a plurality of radial depressions distributed along its periphery. In some embodiments said second portion has a cavity shaped and dimensioned to be engaged by said outer end; and at least one protrusion projecting radially into said cavity, said protrusion being shaped and dimensioned and positioned to selectively mate with said depressions. In some embodiments said second portion has a plurality of said protrusions. In some embodiments said protrusions and said depressions consist of symmetrical meshing indentations. In some embodiments the apparatus further comprises means for locking said coupler upon said shaft. In some embodiments said means for locking comprise: said second portion having a radial gap extending from said cavity to an edge of said coupler; and said second portion further comprises a bolt orthogonally crossing said gap and engaging bores in opposite sections of said second portion astride said gap; whereby the tightening of said bolt resiliently urges closure of said gap, cinching said cavity around said shaft. In some embodiments said bores partially intercept said cavity; and said outer end has an annular groove aligned with said bores and being dimensioned to be engaged by a portion of said bolt. In some embodiments said first portion comprises a stud shaped and dimensioned to engage an axial cavity in said bow. In some embodiments said biasing mechanism comprises at least one spiral spring having a central extremity secured to said shaft and a peripheral extremity secured to said frame.

In some embodiments there is provided that in a mechanism for deploying a tarpaulin cover over the cargo compartment of a truck, wherein the cover is pulled from a reel by at least one bow pivoting along one side of the compartment about a pivot assembly resiliently biased toward the deployed position of the cover, there is an improvement which comprises a coupler between said bows and said pivot assembly, said coupler having an orientation angularly adjustable in relation to said assembly by discrete amounts of no more than 12 degrees. In some embodiments said pivot assembly comprises a spline shaft; and said coupler has a cavity shaped and dimensioned to intimately engage said shaft in a plurality of selectable angular orientations.

### BRIEF DESCRIPTION OF THE DRAWING

FIG. 1 is an exploded prospective view of the splined pivoting assembly according to the invention;

FIG. 2 is a diagrammatic illustration of a first type of spline coupling;

FIG. 3 is a diagrammatic illustration of a second type of spline coupling; and

FIG. 4 is a diagrammatic illustration of the preferred type of spline coupling.

### DESCRIPTION OF THE INSTANT EMBODIMENTS

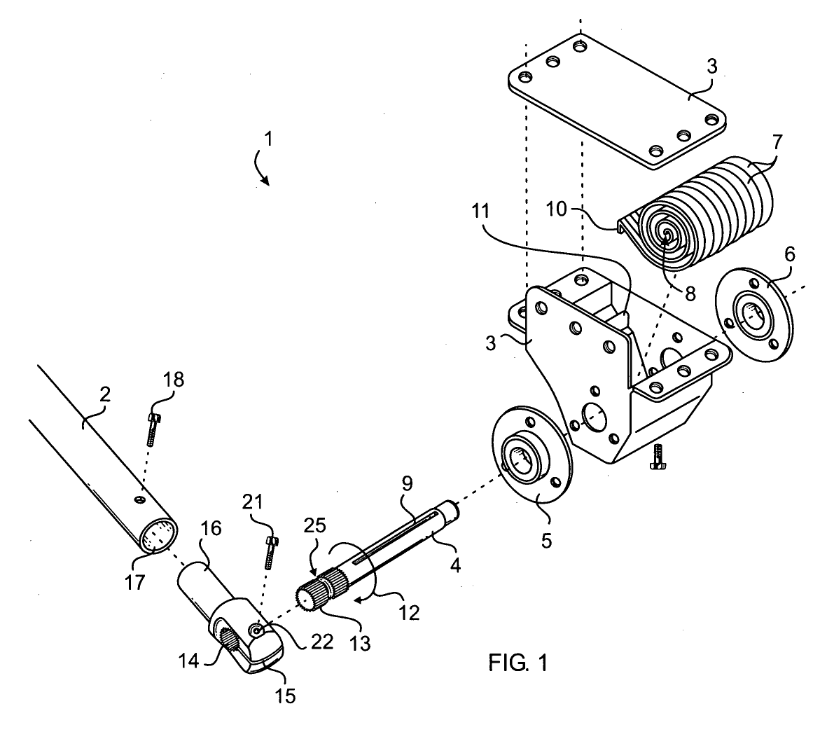

Referring now to the drawing, there is shown in FIG. 1 an apparatus 1 for pivotally mounting a bow 2 of the type shown in reference U.S. Pat. No. 5,031,955 along the side of a truck. Such a bow may be part of a tarpaulin cover deploying mechanism, but could be, along with the invention, a component of another similar structure. An enclosure 3 suitable for attachment to a lower side under-body portion of the truck, forms a frame into which a shaft 4 supported by bearing assemblies 5, 6 is journaled perpendicularly to the side of the truck swept by the bow. The frame houses a biasing mechanism comprising a number of spiral springs 7 engaged side by side over the shaft 4. The inwardly bent central extremity 8 of each spring is caught into an axial groove 9 of the shaft and therefore secured to it. The outwardly bent outer extremity 10 of each spring is secured to the frame 3 by being captured into a grooved ledge 11. Under tension, the springs 7 resiliently urge the shaft 4 into rotating in the clockwise direction indicated by arrow 12. The number of springs can be varied to provide a rough adjustment of the tension applied to the shaft.

The proximal end 13 of the shaft 4 protrudes from the frame 3 and penetrates a circular cavity 14 in a coupler 15. A stud 16 projecting radially from the coupler is shaped, dimensioned and positioned to engage into an aperture 17 in the lower end of the bow 2 where is it secured by a bolt 18.

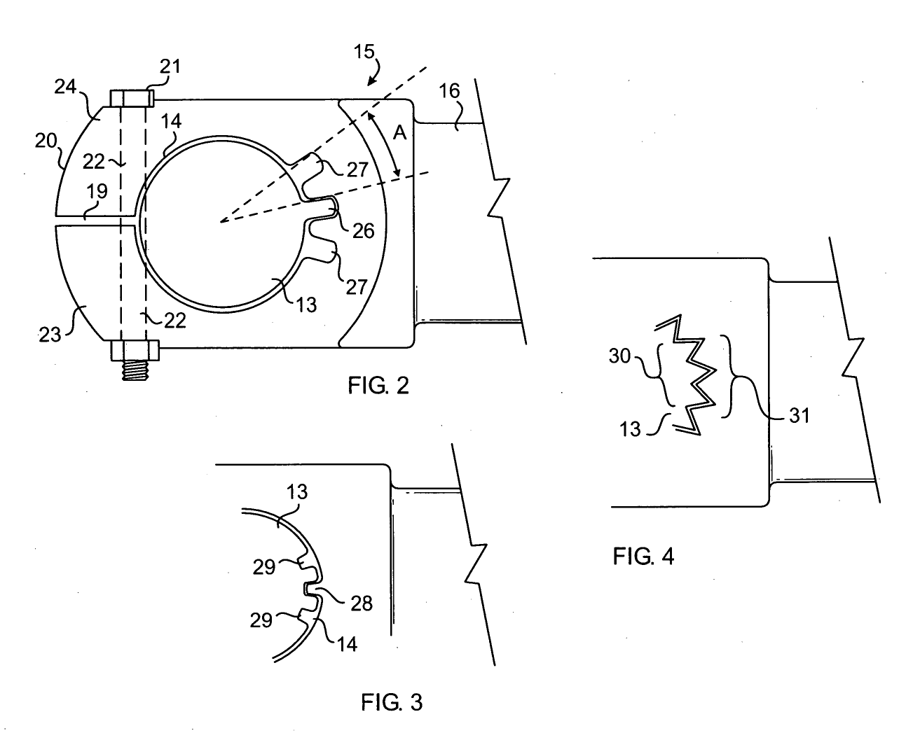

As more specifically illustrated in FIG. 2, the coupler 15 has an axial gap 19 extending from the cavity 14 to the back edge 20 of the coupler. A bolt 21 engaged in bores 22 drilled orthogonally to the gap 19 into opposite sections 23, 24 of the coupler astride the gap is used to resiliently cinch the cavity 14 around the outer end 13 of the shaft.

The bores 22 partially intercept the cavity and engage an annular groove 25 in the outer end 13 of the shaft. Accordingly, the bolt 21 prevents axial translation of the coupler 15 over the shaft 4. The outer end of the shaft 13 and the wall of the coupler cavity 14 are splined with machined protrusions and depressions so that the coupler can be aligned and secured on the shaft in a plurality of discrete angular orientations.

In a first splining example illustrated in FIG. 2, the shaft end 13 has a single radial spur or protrusion 26 that can mesh with one of several depressions 27 in the wall or periphery of the coupler cavity 14. Accordingly, the orientation of the coupler and bow can be varied in discrete angular increments corresponding to the angle A.

In a second example of splining illustrated in FIG. 3, a single spur or protrusion 28 projects radially and inwardly from the wall of the coupler cavity into one of a number of grooves or depressions 29 around the periphery of the shaft end 13.

In the preferred example of splining illustrated in FIG. 4, the entire outer end 13 of the shaft is splined into forming a number of symmetrical spurs and valleys 30 which are shaped, dimensioned and positioned to intimately mesh with corresponding and similar spurs and valleys 31 in the wall of the cavity. The size and number of spurs determines the minimum degrees of incremental orientation of the bow in relation to the shaft. In the preferred embodiment of the invention, the shaft and coupler are splined with 60 teeth yielding an incremental angle A of 6 degrees. It has been determined that in order to accommodate most common types of truck cover deployment systems, the incremental angle A should not exceed 12 degrees.

The invention provides a convenient structure for quickly and accurately coupling a bow to a pivoting mechanism in a wide range of angular orientations that can be precisely set in minute increments for use in a rugged industrial environment such as part of a dump truck tarpaulin cover deploying mechanism. By providing for fine tension adjustment between the shaft and the arm and not necessarily within the enclosure, the enclosure can be made to be less penetratable by water, dust or mud or other potentially fouling agents present in rugged industrial environments.

While the preferred embodiment of the invention has been described, modifications can be made and other embodiments may be devised without departing from the spirit of the invention and the scope of the appended claims.

What is claimed is:

1. An apparatus for pivotally mounting a bow along the side of a truck, which comprises a frame secured to the truck;
a shaft rotationally journaled into said frame along an axis substantially perpendicular to said side;
a biasing mechanism between said shaft and said frame, said mechanism urging said shaft to rotate in a first direction within a plane substantially parallel to said side; and
a coupler having a first portion secured to a lower end of said bow and a second portion adjustably attachable to an outer end of said shaft in a plurality of discrete angular orientations within said plane.

2. The apparatus of claim 1 wherein said angular orientations are regularly separated by no more than about 12 degrees.

3. The apparatus of claim 1 wherein said outer end comprises at least one radial protrusion projecting from the periphery of said shaft.

4. The apparatus of claim 3 wherein said second portion has a cavity shaped and dimensioned to be engaged by said outer end, said cavity having a plurality of radial depressions distributed along the periphery of said cavity, each of said depressions being shaped, dimensioned and positioned to selectively mate with said protrusion.

5. The apparatus of claim 2 wherein said outer end has a plurality of radial depressions distributed along its periphery.

6. The apparatus of claim 5 wherein said second portion has a cavity shaped and dimensioned to be engaged by said outer end; and
at least one protrusion projecting radially into said cavity, said protrusion being shaped and dimensioned and positioned to selectively mate with said depressions.

7. The apparatus of claim 6 wherein said second portion has a plurality of said protrusions.

8. The apparatus of claim 7 wherein said protrusions and said depressions consist of symmetrical meshing indentations.

9. The apparatus of claim 8 which further comprises means for locking said coupler upon said shaft.

10. The apparatus of claim 9 wherein said means for locking comprise:
said second portion having a radial gap extending from said cavity to an edge of said coupler; and
said second portion further comprises a bolt orthogonally crossing said gap and engaging bores in opposite sections of said second portion astride said gap;
whereby the tightening of said bolt resiliently urges closure of said gap, cinching said cavity around said shaft.

11. The apparatus of claim 10 wherein said bores partially intercept said cavity; and
said outer end has an annular groove aligned with said bores and being dimensioned to be engaged by a portion of said bolt.

12. The apparatus of claim 8 wherein said first portion comprises a stud shaped and dimensioned to engage an axial cavity in said bow.

13. The apparatus of claim 1 wherein said biasing mechanism comprises at least one spiral spring having a central extremity secured to said shaft and a peripheral extremity secured to said frame.

14. In a mechanism for deploying a tarpaulin cover over the cargo compartment of a truck, wherein the cover is pulled from a reel by at least one bow pivoting along one side of the compartment about a pivot assembly resiliently biased toward the deployed position of the cover, an improvement which comprises a coupler between said bows and said pivot assembly, said coupler having an orientation angularly adjustable in relation to said assembly by discrete amounts of no more than 12 degrees.

15. The improvement of claim 14 wherein said pivot assembly comprises a spline shaft; and
said coupler has a cavity shaped and dimensioned to intimately engage said shaft in a plurality of selectable angular orientations.
